(19) United States
(12) Patent Application Publication
(10) Pub. No.: US 2026/0329528 A1
(43) Pub. Date: Oct. 22, 2026

(54) System and Method for Parameter-Free Renormalisation of Physical Constants -Deterministic Algorithm and Integrated-Circuit Architecture for Computing Renormalised Fundamental Constants from Recognition Physics First Principles

(71) Applicant: Jonathan Washburn, Austin, TX (US)

(72) Inventor: Jonathan Washburn, Austin, TX (US)

(21) Appl. No.: 19/652,452

(22) Filed: Apr. 20, 2026

Related U.S. Application Data
(60) Provisional application No. 63/792,736, filed on Apr. 22, 2025.

(51) Int. Cl. G06F 5/01; G06F 7/544

(52) U.S. Cl. CPC G06F 5/01; G06F 7/5443

(57) ABSTRACT

Methods, systems, integrated circuits, and computer-readable media are disclosed for deterministic, parameter-free renormalisation of physical constants. A computation engine receives a target identifier and a scale input, determines a coverage-fit minimizer, determines a loop correction ratio and a loop correction parameter, loads a target profile including coefficient data and running-function definitions, and evaluates a bounded renormalisation series to generate a machine-actionable renormalised output together with at least one status, verification, profile-identification, or release-state field. In some embodiments, the engine includes a derivation engine, a series-evaluation engine, and an optional kernel engine configured to apply a secondary transform for selected targets. In some embodiments, the architecture is implemented in an ASIC, FPGA, processor-executed software library, or hybrid hardware/software system. Representative outputs include fine-structure-related quantities, gravitational-constant-related quantities, cosmological-constant-related quantities, mass-ratio-related quantities, weak-mixing-related quantities, and strong-coupling-related quantities.

### CROSS-REFERENCE TO RELATED APPLICATIONS

This application claims the benefit of U.S. Provisional Patent Application No. 63/792,736, filed on Apr. 22, 2025.

### BACKGROUND OF THE INVENTION

The present disclosure relates to computational physics, deterministic computation of renormalised physical constants, semiconductor accelerator design, numerical methods for evaluating physical constants across energy scales, and instrumentation and simulation systems that use such computed constants in machine-executable workflows.

More particularly, the present disclosure relates to systems, methods, integrated circuits, and computer-readable implementations configured to compute one or more renormalised physical constants from a disclosed transform chain using predetermined recognition-based quantities, predetermined coefficient structures, and deterministic scale-dependent evaluation logic, without inserting empirical counter-terms into the disclosed internal computational path.

Conventional renormalisation workflows in quantum field theory and adjacent computational-physics environments typically depend on scheme-specific procedures in which bare quantities, counter-terms, subtraction conventions, and empirically selected reference values are iteratively combined to obtain reported physical quantities at selected scales. In many practical implementations, the numerical workflow is distributed across symbolic tools, numerical solvers, conversion tables, scheme-matching procedures, and post-processing software layers. Even where such workflows are scientifically useful, they can be operationally difficult to embed into deterministic, low-latency hardware pipelines because the computation path may depend on iterative convergence behavior, branch-heavy software logic, repeated external parameter injection, or toolchain-specific data handling.

Those conventional approaches present several technical shortcomings when viewed from the standpoint of deployable computation engines, embedded control systems, and accelerator hardware. One shortcoming is that the computational path is often not architected as a fixed, bounded-latency transform chain suitable for a dedicated pipeline. Instead, the computation may rely on software-managed iteration depth, runtime-selected subtraction rules, or repeated numerical refinement that complicates hardware scheduling, timing closure, power budgeting, and real-time integration. Another shortcoming is that multiple constants or target outputs may be handled by different numerical procedures or disconnected tool modules, which increases implementation complexity and reduces the practicality of a unified co-processor capable of serving different host systems with consistent execution logic.

A further shortcoming is that conventional implementations frequently require repeated importation of empirically selected or scheme-specific values into the active numerical path. In a software context, that may be acceptable, but in an embedded or instrument context it can create a control-flow problem because the output depends not only on the incoming runtime inputs but also on external parameter tables, conversion logic, version-dependent scheme choices, or calibration decisions injected into intermediate stages of the computation. That architecture can impair reproducibility, complicate auditability, and make it more difficult to guarantee that identical runtime inputs will produce identical outputs across devices, tool versions, or deployment environments.

Another technical shortcoming arises in systems that must re-evaluate constants in real time or near real time. Gravimeters, navigation engines, simulation accelerators, edge devices, and closed-loop control platforms may benefit from very fast, deterministic evaluation of a target constant as a function of an input scale or operating condition. General-purpose processors can perform such computations, but they are not necessarily optimized for a fixed transform chain involving repeated multiply-accumulate operations, bounded-order series evaluation, optional kernel processing, and target-profile switching under deterministic timing constraints. As a result, latency, power consumption, integration overhead, and software complexity can become limiting factors, particularly where the constant evaluation is not a one-time offline step but is part of a recurring operational loop.

Conventional approaches also tend to separate the derivation logic, the numerical-evaluation logic, and the deployment logic into different software or hardware layers without a unified execution architecture. For example, a symbolic derivation tool may generate expressions, a separate numerical engine may evaluate those expressions, and yet another system may attempt to package the result for an instrument, simulator, or accelerator. That fragmentation matters because it increases opportunities for inconsistency between the formula selection stage, the coefficient-selection stage, the scale-running stage, and the final output stage. It also complicates implementation of provenance tracking, deterministic builds, formal verification, and hardware/software equivalence checking.

In addition, conventional constant-evaluation architectures often do not provide an integrated way to switch among different target constants using a common execution framework and target-specific profile data. Instead, one constant may be computed through one dedicated routine, another through a different solver stack, and another through a manually assembled combination of formulas and lookup values. This matters operationally because it inhibits construction of a single reusable engine that can be incorporated into metrology devices, simulation platforms, semiconductor accelerators, or distributed compute services while preserving deterministic behavior and reducing duplicate implementation effort.

There is therefore a technical need for a concrete computational architecture that expresses renormalised-constant evaluation as a deterministic transform chain having bounded and machine-implementable stages, objective input and output definitions, and target-specific configurability without requiring repeated insertion of empirical counter-terms into the disclosed internal path. There is a further technical need for such an architecture to be implementable not only in software but also in dedicated hardware, including integrated circuits, FPGA-based accelerators, and hybrid hardware/software systems. There is also a need for a unified engine capable of producing different renormalised outputs through profile selection, rather than through replacement of the core computational pipeline.

There is also a technical need for an architecture that supports reproducibility, auditability, and verification. In practical deployment, it is advantageous for a constant-computation engine to support deterministic execution, profile-controlled operation, bounded loop order, explicit fallback behavior, versionable coefficient data, optional verification metadata, and stable machine-actionable outputs that can be consumed by host devices, simulation engines, measurement platforms, and control systems. It is further advantageous if the same architecture can support local execution, remote execution, offline execution, online execution, batch execution, and embedded execution while preserving the same underlying computational structure.

The present disclosure addresses these and other technical problems by providing a deterministic renormalisation engine that computes one or more renormalised physical constants from a disclosed transform chain including derivation of a coverage-fit minimizer, derivation of one or more loop-related quantities, selection of a target-specific coefficient profile, and finite series evaluation, with optional kernel-based secondary processing for selected embodiments. The disclosed architecture is amenable to integrated-circuit implementation, low-latency pipelining, software-library deployment, and multi-target reuse, thereby providing a concrete technical solution to the shortcomings discussed above.

In some embodiments, the disclosed invention improves computer and machine operation not by merely reporting a mathematical result, but by constraining renormalised-constant evaluation to an objective machine-executable architecture having bounded stages, bounded loop depth, profile-validated execution, deterministic scheduling, and machine-actionable output gating. In some embodiments, the architecture reduces branch-heavy solver variability, reduces repeated external parameter injection into the active computational path, improves cross-platform reproducibility between hardware and software implementations, and enables low-latency use of the renormalised output in instrument control loops, simulation state-update paths, accelerator execution paths, or other automated machine workflows. These improvements arise from the disclosed arrangement of derivation engine, target-profile-controlled series evaluation, optional kernel staging, validation logic, and release-state-controlled output handling, rather than from mere presentation of a calculated value.

### SUMMARY OF THE INVENTION

The present disclosure provides systems, methods, integrated circuits, software modules, and computer-readable implementations for deterministic, parameter-free renormalisation of physical constants using a bounded computational transform chain that is structured for direct implementation in hardware, software, or hybrid hardware/software environments. In representative embodiments, the disclosed architecture receives a target constant selection and an input scale, determines a coverage-fit minimizer, determines one or more loop-related quantities from the disclosed recognition-based transform chain, selects a target-specific computational profile, evaluates a finite renormalisation series, and outputs a machine-actionable renormalised constant for use by a host device, simulation engine, instrument, controller, or downstream computation module.

In a first aspect, the disclosure provides a computer-implemented method for computing a renormalised physical constant. The method can include receiving a target constant identifier corresponding to a selected output quantity, receiving a scale input corresponding to an energy scale, momentum-transfer scale, local operating scale, field-dependent scale, or other selected computational scale, determining a coverage-fit minimizer X_opt from a disclosed coverage-fit relation, determining a loop correction ratio R_RP and a loop correction parameter delta_loop from the disclosed transform chain, selecting a predetermined target profile associated with the selected output quantity, and evaluating a finite renormalisation series using predetermined coefficient data and one or more predetermined scale-running definitions associated with the selected target profile. The method can further include generating a machine-actionable output value representing the renormalised constant together with at least one status, verification, profile-identification, or release-state field and providing that output to a local or remote consumer system.

In representative embodiments, the disclosed computational path uses the following recognition-based quantities and relations as part of the transform chain:
J_RS(x)=0.5(x+x\hat{ }(−1))−1; J_cov(X)=integral from 0 to infinity of [(x/(x+X))\hat{ }2−phi\hat{ }(−2)]\hat{ }2 dx; X_opt=phi/pi; R_RP=7/12; eta_RP=sqrt(5/8); delta_loop=X_opt\hat{ }(1+R_RP); and C_ren(mu)=sum from n=0 to N of a_n·delta_loop\hat{ }n·f_n(mu/mu_0), where phi is the golden ratio, a_n denotes predetermined coefficients for a selected target profile, f_n(mu/mu_0) denotes one or more predetermined running functions or scale-transport functions associated with that target profile, mu is a selected input scale, mu_0 is a reference scale, and N is a selected truncation order. These relations may be implemented exactly, approximately, analytically, numerically, by lookup, by interpolation, by fixed-point logic, by floating-point logic, or by mixed-precision logic, depending on the selected embodiment.

In some embodiments, determination of X_opt is performed by a solver subsystem configured to evaluate a derivative condition associated with the coverage-fit relation and to update an estimate using Newton iteration, Halley iteration, a Newton-Halley hybrid, a stored verified approximation, or another deterministic update rule. In some embodiments, the solver operates during initialization and the resulting X_opt value is reused for multiple target evaluations. In some embodiments, the solver is callable on demand. In some embodiments, a fallback mode can be invoked if a convergence condition, range condition, precision condition, or iteration budget condition is not satisfied. Such fallback mode can include use of a stored table value, a bounded approximation, a lower-precision operating mode, or a host-directed retry mode.

In another aspect, the disclosure provides a system architecture that organizes renormalised-constant computation as an integrated dataflow. In representative embodiments, the system includes an input interface configured to receive a target identifier and scale input, a derivation engine configured to determine X_opt, R_RP, and delta_loop, a target-profile memory configured to store coefficient data and running-function definitions, a series-evaluation engine configured to evaluate a bounded-order renormalisation series, an optional kernel engine configured to apply a secondary transform for selected targets or physical models, control circuitry configured to schedule and validate execution, and an output interface configured to provide a result in machine-readable form together with at least one status, verification, profile-identification, or release-state field. In some embodiments, the result is written to a register set, memory location, message buffer, network payload, control register, instrument interface, or simulation callback structure together with at least one status, verification, profile-identification, or release-state field.

In another aspect, the disclosure provides an integrated-circuit embodiment configured to perform all or part of the disclosed transform chain. In representative implementations, the integrated circuit includes a Sigmoid Mapping Unit configured to map an input scalar to a bounded domain value, a Series-Evaluation Module configured to evaluate a finite renormalisation series using Horner-form or equivalent staged multiply-accumulate logic, and an optional Fractional-Kernel Engine configured to apply a secondary transform, including a gravity-related kernel in selected embodiments. In some implementations, the Sigmoid Mapping Unit computes or approximates X=1/(1+exp(−2beta g_s)), where beta may satisfy beta=pi/phi=1/X_opt and g_s is an input scalar or application-dependent source value. In some implementations, the Series-Evaluation Module uses hardwired coefficients, memory-loaded coefficients, or register-loaded coefficients. In some implementations, the optional Fractional-Kernel Engine performs spectral-domain processing using a stored or programmable exponent parameter and can be selectively bypassed without altering the core renormalisation path for targets that do not require kernel processing.

In some integrated-circuit embodiments, the execution path is organized as a bounded-latency pipeline having a first stage associated with mapping or preprocessing, a second stage associated with series evaluation, and a third stage associated with optional kernel processing. In exemplary implementations described herein, a three-stage accelerator includes a Sigmoid Mapping Unit, a Series-Evaluation Module, and a Fractional-Kernel Engine, with a representative total latency of thirty-eight clock cycles for a selected six-loop implementation. In some embodiments, the total latency remains fixed for timing determinism even when the optional kernel stage is bypassed. In some embodiments, bypass shortens total latency. In some embodiments, the pipeline is configured for low-power semiconductor implementation, including ASIC or FPGA deployment. In some embodiments, pipeline control logic supports stage validity signals, completion flags, reset behavior, precision-mode selection, and fault or fallback handling.

In another aspect, the disclosure provides a target-profile architecture that allows multiple renormalised constants to be computed by a common computation engine. Each target profile may include a target identifier, one or more coefficient arrays, one or more reference-scale definitions, one or more running-function definitions, a loop-order limit, a precision mode, optional provenance metadata, and optional verification metadata. In some embodiments, the one or more running-function definitions comprise at least one of (i) a lookup table with interpolation coefficients, (ii) a piecewise polynomial or spline approximation defined over breakpoint intervals, or (iii) an analytic expression executable by the computation engine. In one representative target profile, the stored data include a target identifier, a reference scale mu_0, coefficients a_0 through a_6, and, for at least one running-function definition, either lookup-table entries and interpolation coefficients, polynomial-segment coefficients and breakpoint values, or analytic-function parameters associated with the selected target. By way of concrete implementation example, for a fine-structure-related quantity, the running-function definition can be stored as a lookup table over breakpoint intervals of mu/mu_0 together with interpolation coefficients such that running-function generator 216 retrieves adjacent entries corresponding to the supplied scale input and computes an interpolated f_n(mu/mu_0) value for delivery to the series-evaluation engine, while coefficients a_0 through a_6 remain stored in the selected target profile for staged Horner-form evaluation. In this manner, the same computation engine can be reused for different outputs by profile selection rather than by replacing the algorithmic core. Although a common computation engine can be reused across multiple target families, the present disclosure does not require every embodiment to support every target constant, every running-function definition, every arithmetic mode, every loop-order limit, or every optional kernel path. In some embodiments, a first implementation supports only a subset of target profiles. In some embodiments, a second implementation supports additional target profiles, additional loop depths, or additional post-processing paths. In some embodiments, different target profiles are validated, released, or authorized independently, and a given embodiment may omit profiles, operating modes, or target families that are unnecessary for the intended deployment while still remaining within the disclosed invention so long as the embodiment preserves the disclosed deterministic transform-chain architecture.

Representative targets include a fine-structure-related quantity, a gravitational constant-related quantity, a cosmological constant-related quantity, an electron-to-proton mass-ratio-related quantity, a weak-mixing-related quantity, a strong-coupling-related quantity, and other selected derived outputs. In some embodiments, the target profile also stores post-processing rules, output-format rules, range checks, or verification conditions associated with the selected target. In another aspect, the disclosure provides software and computer-readable embodiments of the same architecture. In representative embodiments, the disclosed transform chain is packaged as a C++ library, language binding, firmware module, simulation plug-in, cloud service, device driver, or hybrid software/hardware interface. In some embodiments, a software call receives a target identifier, an input scale, and an optional loop-order or mode indicator, and returns a machine-actionable renormalised constant value in a deterministic format together with at least one status, verification, profile-identification, or release-state field. In some embodiments, the software path and the hardware path share the same target-profile definitions, coefficient sets, verification metadata, or deterministic-build metadata, thereby supporting equivalence checking between software execution and accelerator execution. In some embodiments, the disclosed architecture is deployed in local devices, distributed systems, cloud services, embedded controllers, edge devices, or offline batch tools.

In some embodiments, the disclosed system further includes validation, audit, or verification logic. Such logic can compare a computed output against a permitted range, a stored reference, a theorem-backed bound, a precision threshold, or an application-specific acceptance condition. In some embodiments, the validation logic distinguishes between internal computational validity, external reporting conversion, and release eligibility for control use under an active profile and operating mode. In some embodiments, the system stores provenance metadata indicating which target profile, coefficient set, version identifier, theorem identifier, or configuration state was used to compute a particular output. In some embodiments, this supports auditability, reproducibility, regulated deployment, or cross-environment consistency checking.

In selected embodiments, the disclosed architecture can be integrated into metrology systems, gravimeters, simulation engines, collider event generators, molecular-dynamics tools, edge-AI devices, navigation systems, spacecraft trajectory systems, and other machine systems that benefit from deterministic and reusable constant evaluation, wherein the renormalised output is generated under a bounded-latency scheduling policy and is consumed by a control loop, instrument interface, simulator state-update path, or other machine-execution path as a practical machine control input rather than as a merely human-readable mathematical result. In such embodiments, the renormalised constant output may be consumed as a control input, simulation parameter, calibration quantity, force-model input, optimization parameter, comparison quantity, or diagnostic signal, provided that the output is accompanied by at least one status, verification, profile-identification, or release-state field sufficient for the receiving machine path to distinguish control-eligible outputs from blocked, degraded, historical-only, comparison-only, replay-only, or non-control-use outputs. The disclosed architecture therefore provides not merely a mathematical expression but a concrete machine-implementable computational system with bounded stages, stored target profiles, objective transform logic, configurable operating modes, optional fallback behavior, and machine-actionable outputs.

In some embodiments, the generated renormalised output is not merely displayed, printed, or stored for human review, but is consumed by downstream machine logic that gates, updates, schedules, recalibrates, enables, disables, compares, or otherwise controls a subsequent machine operation according to the accompanying status, verification, profile-identification, or release-state data. In some embodiments, the output changes whether a control loop uses a value, whether a simulator advances with a selected parameter set, whether an accelerator path is enabled, whether a result is accepted for operational use, or whether a fallback or blocked state is invoked. Accordingly, the disclosed output architecture forms part of a concrete machine-control workflow rather than merely constituting post-solution presentation of information.

In another aspect, the disclosure provides non-transitory computer-readable media storing instructions that, when executed by one or more processors, cause the processors to perform one or more of the foregoing methods. In another aspect, the disclosure provides a co-processor, semiconductor device, system-on-chip, field-programmable gate array image, firmware package, or mixed hardware/software subsystem configured to perform one or more of the foregoing methods. In another aspect, the disclosure provides a deployment model in which one or more derived quantities, such as X_opt, R_RP, or delta_loop, are computed once and reused across multiple target evaluations, while target-specific outputs are distinguished through target-profile selection, scale-running selection, and optional post-processing or kernel execution.

The disclosed architecture yields several concrete technical effects in representative embodiments. These can include deterministic output generation for identical inputs and profiles, reduced implementation complexity through reuse of a common target-profile-driven computation engine, lower-latency evaluation relative to branch-heavy iterative software workflows, suitability for bounded hardware pipelining, reduction of repeated parameter injection into the disclosed internal computational path, improved support for reproducibility, auditability, and cross-platform consistency, and reduced release ambiguity through explicit blocking-fault handling and verification-gated output control. These technical effects arise from the particular combination of derivation logic, profile-driven coefficient selection, bounded-order series evaluation, optional kernel staging, and explicit machine-oriented control architecture disclosed herein, rather than from a generic aggregation of unrelated computational components. The foregoing summary is provided to introduce selected concepts in simplified form and is not intended to identify every required feature of every embodiment or to limit the scope of the claimed subject matter. Other aspects, features, combinations, subcombinations, alternatives, implementations, operating modes, and advantages will become apparent from the following description, drawings, and claims.

### BRIEF DESCRIPTION OF THE DRAWINGS

FIG. 1 is a high-level block diagram of a parameter-free renormalisation system 100 including an input interface 102, a target selector 104, a scale input block 106, a loop-order input block 108, a derivation engine 110, a series engine 112, an optional kernel engine 114, an output interface 116, a host device 118, a coefficient memory 120, a control bus 122, a data bus 124, a profile cache 126, and a result register 128.

FIG. 2 is a logical derivation workflow 200 including a recognition input block 202, a cost-functional block 204, a coverage-fit block 206, an X_opt block 208, an R_RP block 210, a delta_loop block 212, a coefficient-set selector 214, a running-function generator 216, a renormalised-constant evaluator 218, a verification/output block 220, a profile-selection decision node 222, a fallback path 224, a scale-normalization path 226, and a cached-value path 228.

FIG. 3 is a solver subsystem 300 including an initial interval block 302, a first-derivative evaluator 304, a second-derivative evaluator 306, a third-derivative evaluator 308, an update block 310, a convergence test 312, an iteration counter 314, a converged output block 316, an exception/fallback block 318, a precision controller 320, a residual threshold input 322, a step-size threshold input 324, a monotonicity check 326, a retry path 328, a stored approximation source 330, and a hard-failure output 332.

FIG. 4 is a target-profile data structure 400 including a target library 402, a target identifier 404, a first coefficient array 406, a second coefficient array 408, a reference-scale field 410, a running-function definition field 412, a loop-order limit field 414, a precision-mode field 416, a provenance field 418, a verification field 420, a target family field 422, a profile version field 424, an authentication field 426, a checksum/signature field 428, a post-processing rule field 430, an output-format field 432, a kernel-enable field 434, and an arithmetic-policy field 436.

FIG. 5 is a Sigmoid Mapping Unit 500 including an input scalar block 502, a scaling block 504, a lookup table 506, an interpolation block 508, a formatter 510, an X register 512, a bypass controller 514, a latency counter 516, a calibration port 518, an output bus 520, a beta input 522, a LUT address generator 524, a LUT value output 526, and an interpolation coefficient store 528.

FIG. 6 is a Series-Evaluation Module 600 including a delta register 602, a coefficient register bank 604, a first multiply-accumulate stage 606, a second multiply-accumulate stage 608, a third multiply-accumulate stage 610, a fourth multiply-accumulate stage 612, a fifth multiply-accumulate stage 614, a sixth multiply-accumulate stage 616, a Horner controller 618, an accumulator 620, a formatter 622, an output register 624, a coefficient loader 626, a stage-valid pipeline 628, an overflow/underflow detector 630, a loop-depth selector 632, an intermediate result bus 634, and a rounding control 636.

FIG. 7 is a Fractional-Kernel Engine 700 including a kernel enable input 702, a spatial input buffer 704, a forward transform block 706, a spectral multiplier 708, an inverse transform block 710, a gravity-potential output block 712, an exponent parameter register 714, a kernel memory 716, a bypass multiplexer 718, an output buffer 720, a kernel mode selector 722, a transform-length selector 724, a coefficient fetch path 726, a bypass-valid signal 728, a transformed-data bus 730, and a kernel-status flag 732.

FIG. 8 is a control and timing subsystem 800 including a clock input 802, a reset input 804, a stage scheduler 806, a first valid line 808, a second valid line 810, a third valid line 812, a latency counter 814, a power controller 816, a status block 818, a completion flag 820, a fixed-latency mode input 822, a variable-latency mode input 824, a blocking-fault flag 826, a recoverable-fault flag 828, a stage-enable output 830, and a clock-gate control 832.

FIG. 9 is an integrated-circuit embodiment 900 including a package substrate 902, a renormalisation core 904, an external interface 906, a host processor 908, a memory 910, a sensor or external-source input 912, an interconnect 914, a power-management block 916, a thermal sensor 918, an external output device 920, a control register block 922, a target register block 924, a scale register block 926, and a result register block 928.

FIG. 10 is a software-stack embodiment 1000 including an API layer 1002, a C++ library 1004, a Python binding 1006, a Rust binding 1008, a MATLAB binding 1010, a Julia binding 1012, a simulation plug-in 1014, a deterministic-build module 1016, a verification module 1018, a user application 1020, a result log 1022, a profile repository 1024, a build manifest 1026, a checksum store 1028, a replay module 1030, an audit export path 1032, and a hardware equivalence checker 1034.

FIG. 11 is a deployment environment 1100 including a gravimeter embodiment 1102, a molecular-dynamics embodiment 1104, a collider-simulation embodiment 1106, an edge-AI embodiment 1108, a spacecraft-navigation embodiment 1110, a scale input 1112, a renormalised-constant output 1114, a control loop 1116, a comparison block 1118, a diagnostic output 1120, a local execution path 1122, a remote execution path 1124, a baseline/reference source 1126, and an alert output 1128.

FIG. 12 is a method flow 1200 including a target-receive step 1202, a scale-receive step 1204, an X_opt determination step 1206, an R_RP determination step 1208, a delta_loop determination step 1210, a target-profile load step 1212, a series-evaluation step 1214, an optional-kernel step 1216, an output-generation step 1218, a store-or-transmit step 1220, a verification step 1222, an end state 1224, a profile-validation branch 1226, a fallback branch 1228, a cache-hit branch 1230, a cache-miss branch 1232, a kernel-bypass branch 1234, and a kernel-enabled branch 1236.

### DETAILED DESCRIPTION OF THE INVENTION

In the following description, like reference numerals refer to like or corresponding structures, functions, data objects, signals, or operational states unless the context clearly indicates otherwise. The disclosed embodiments are presented to enable a person of ordinary skill in the art to make and use the claimed subject matter and to demonstrate possession of a range of implementations, variations, and fallback configurations. The drawings are schematic and are not necessarily to scale. Unless expressly stated otherwise, terms such as local, remote, host-side, device-side, upstream, downstream, first, second, and third are used for explanatory convenience and do not require a particular orientation, packaging arrangement, or execution order. Unless expressly required by the claims, any disclosed feature may be used alone, in combination with other disclosed features, omitted, substituted, reordered, scaled, distributed, virtualized, locally implemented, remotely implemented, hardware-implemented, software-implemented, firmware-implemented, or implemented in a hybrid manner.

As used herein, “parameter-free” means that the disclosed internal computational path for determining one or more intermediate quantities, selecting a target profile, and generating a renormalised output is executed without inserting empirical counter-terms, ad hoc fitted correction factors, or scheme-conversion parameters into the disclosed transform chain itself. This usage does not exclude predetermined coefficients, predetermined profile data, predetermined operating modes, predetermined initialization data, optional external reporting conversions, optional profile-version identifiers, or optional verification metadata. As used herein, “deterministic” means that, for a given accepted input set, active profile set, arithmetic mode, and execution state, the system produces the same machine-actionable result within the precision bounds of the selected embodiment. As used herein, “target constant” includes a physical constant, coupling, ratio, vacuum-related quantity, transport quantity, or other predetermined target output associated with a selected target profile. As used herein, “running function” includes an analytic function, lookup-table representation, piecewise representation, interpolated representation, threshold-matched representation, or another deterministic scale-dependent definition associated with a selected target profile. As used herein, “machine-actionable output” means an output representation that can be consumed by a processor, controller, simulator, instrument, communication interface, register-mapped device, storage object, or automated downstream system without human reinterpretation.

In the disclosed computational framework, one representative cost relation is J_RS(x)=0.5(x+x\hat{ }(−1))−1. One representative coverage-fit relation is J_cov(X)=integral from 0 to infinity of [(x/(x+X))\hat{ }2−phi\hat{ }(−2)]\hat{ }2 dx. One representative minimizer is X_opt=phi/pi, where phi is the golden ratio. One representative loop-related ratio is R_RP=7/12. One representative additional derived quantity is eta_RP=sqrt(5/8). One representative loop parameter is delta_loop=X_opt\hat{ }(1+R_RP). One representative renormalisation series is C_ren(mu)=sum from n=0 to N of a_n·delta_loop\hat{ }n·f_n(mu/mu_0), where a_n are predetermined coefficients associated with a selected target profile, f_n(mu/mu_0) are predetermined running functions associated with the selected target profile, mu is a selected input scale, mu_0 is a reference scale, and N is a selected truncation order. These equations are representative and non-limiting. In some embodiments, one or more of the relations are evaluated exactly. In some embodiments, one or more are evaluated numerically, approximately, by interpolation, by fixed-point logic, by floating-point logic, by mixed-precision logic, or by a verified stored approximation. In some embodiments, one or more values are computed at initialization and then reused. In some embodiments, one or more values are recomputed on demand or in response to a mode change, profile change, validation request, or host command.

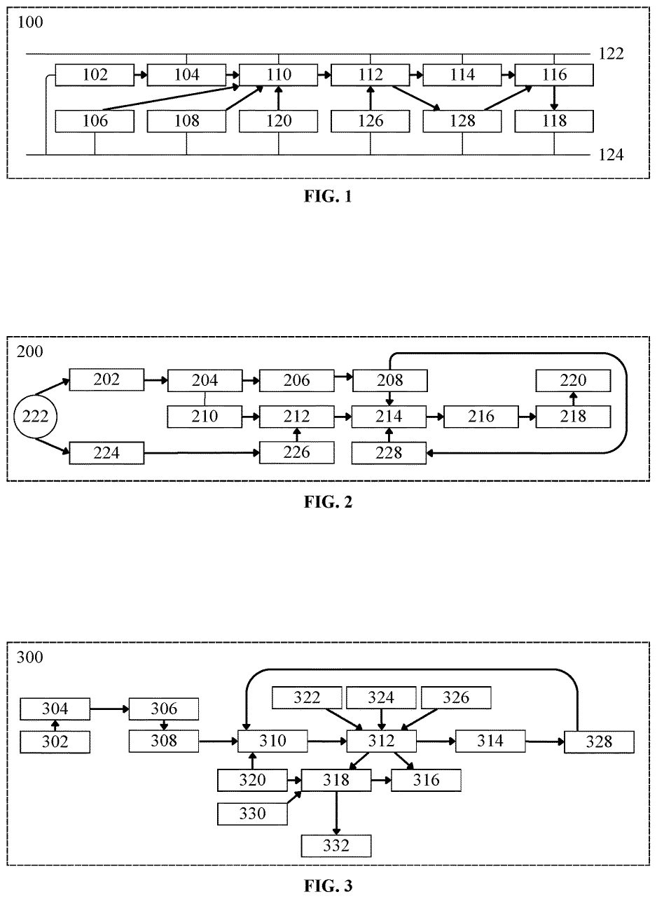

In the embodiment of FIG. 1, a parameter-free renormalisation system 100 is configured to receive inputs, determine one or more derived quantities, select target-specific data, evaluate a bounded computation path, and output a renormalised target quantity. The system 100 includes an input interface 102, a target selector 104, a scale input block 106, a loop-order input block 108, a derivation engine 110, a series engine 112, an optional kernel engine 114, an output interface 116, a host device 118, a coefficient memory 120, a control bus 122, a data bus 124, a profile cache 126, and a result register 128. In some embodiments, the system 100 is implemented as a stand-alone semiconductor device. In some embodiments, the system 100 is implemented as a co-processor coupled to a host processor. In some embodiments, the system 100 is implemented as a software module executed on a general-purpose processor. In some embodiments, the system 100 is partitioned across local and remote compute resources. The arrangement shown in FIG. 1 is functional and architectural rather than limiting as to physical packaging.

In the operation of system 100, the input interface 102 receives one or more inbound values or commands from the host device 118 or another source. Such inbound values can include a target identifier, a requested output mode, a selected arithmetic mode, an input scale, a loop-order limit, a kernel-enable flag, a validation request, a profile-selection override, a profile-version selection, or a reporting-format selection. The target selector 104 resolves which target profile is to be used. In some embodiments, the target selector 104 receives an explicit target code from the host device 118. In some embodiments, the target selector 104 resolves the target profile based on a device mode, sensor source, application context, or workflow state, subject to the ordered objective profile-selection rules associated with target library 402 and the active policy state. The scale input block 106 receives a scale quantity corresponding to an energy scale, a field scale, a momentum-transfer proxy, an operating state, a local simulation value, a sensor-derived quantity, or another predetermined scalar or vector-derived scalar accepted by the selected target profile. The loop-order input block 108 receives a loop-order limit or execution-depth selection. In some embodiments, the loop-order input block 108 receives a user-selected N value. In some embodiments, the loop-order input block 108 is constrained by the selected target profile such that unsupported values are clipped, rejected, or replaced with a permitted fallback depth.

In the operation of system 100, the derivation engine 110 determines one or more shared quantities, including X_opt, R_RP, delta_loop, beta, eta_RP, or other profile-independent or profile-conditioned quantities used by the selected computational path. In some embodiments, the derivation engine 110 performs a numerical solve for X_opt. In some embodiments, the derivation engine 110 retrieves a verified stored value of X_opt from coefficient memory 120 or profile cache 126. In some embodiments, the derivation engine 110 computes delta_loop directly from X_opt and R_RP. In some embodiments, the derivation engine 110 validates each derived quantity against one or more range or consistency constraints before releasing the quantity to downstream logic, and when a derived quantity fails validation the system invokes a fallback mode, blocks release of the failed quantity, or marks a degraded operating state according to an active policy. The series engine 112 evaluates the renormalisation series associated with the selected target profile. The optional kernel engine 114 applies a secondary transform in embodiments that require additional processing, such as gravity-related embodiments or other target-specific transforms. The output interface 116 formats and emits the resulting output. The coefficient memory 120 stores target-profile data, coefficient data, running-function definitions, verification data, and optionally cached derived values. The control bus 122 carries scheduler, enablement, and status-control signaling among system blocks. The data bus 124 carries numerical values, intermediate values, or formatted output values among system blocks. The profile cache 126 stores one or more active or recently used profiles for reduced latency during repeated requests. The result register 128 stores a current output, a last-valid output, or an output plus associated status bits, and in some embodiments the associated status bits include a release-state indication identifying the output as current-use, historical-only, comparison-only, replay-only, blocked, degraded, or non-control-use.

In some implementations of system 100, profile-specific variability is intentionally isolated to selected data structures in coefficient memory 120, profile cache 126, and selected control values accepted by input interface 102, while the principal architectural path through derivation engine 110, series engine 112, optional kernel engine 114, and output interface 116 remains stable across different targets. This architecture reduces the need to deploy different solvers or different code modules for different constants. It also supports deterministic scheduling, simplified verification, and reuse of the same physical pipeline or code path across multiple applications. In some embodiments, the output interface 116 transmits the result as an interrupt-backed completion payload that includes at least one accompanying status, verification, policy-state, release-state, or profile-version indicator associated with the active profile and operating mode. In some embodiments, the output interface 116 streams results to a simulator, controller, or sensor fusion system only together with at least one accompanying status, verification, policy-state, release-state, or profile-version indicator associated with the active profile and operating mode. In some embodiments, the output interface 116 provides both a numerical result and associated metadata including status, profile identifier, arithmetic mode, convergence state, provenance information, or release-state information, and in some embodiments the associated metadata further includes a verification state, a profile version identifier, an integrity value corresponding to an authenticated profile or executable artifact, or a release-eligibility or non-control-use indication associated with the active profile and operating mode.

In the embodiment of FIG. 2, a logical derivation workflow 200 represents the principal transform chain for determining the renormalised output. The workflow 200 includes a recognition input block 202, a cost-functional block 204, a coverage-fit block 206, an X_opt block 208, an R_RP block 210, a delta_loop block 212, a coefficient-set selector 214, a running-function generator 216, a renormalised-constant evaluator 218, a verification/output block 220, a profile-selection decision node 222, a fallback path 224, a scale-normalization path 226, and a cached-value path 228. In one implementation, the recognition input block 202 provides a predetermined recognition-based structural input or framework state from which the cost-functional block 204 instantiates J_RS(x). The coverage-fit block 206 instantiates or evaluates J_cov(X) or an equivalent relation. The X_opt block 208 determines the minimizer or retrieves a previously determined minimizer. The R_RP block 210 provides the predetermined ratio 7/12 or another target-supported ratio in an alternative disclosed embodiment. The delta_loop block 212 computes delta_loop. The coefficient-set selector 214 selects the coefficient set associated with the active target profile. The running-function generator 216 generates or retrieves one or more scale-running definitions. The renormalised-constant evaluator 218 evaluates the bounded series or equivalent staged transform. The verification/output block 220 validates, formats, and releases the result, and in some embodiments appends a release-state indication identifying whether the result is current-use, historical-only, comparison-only, replay-only, blocked, degraded, or non-control-use.

In some embodiments of workflow 200, the profile-selection decision node 222 determines whether a requested target corresponds to an available current-use profile, a historical profile, a comparison-only profile, a replay-only profile, a remote profile, or a fallback-authorized substitute profile. In some embodiments, fallback path 224 is invoked if the requested target profile is absent, malformed, cryptographically unverified, inconsistent with a requested arithmetic mode, otherwise unavailable, associated with an integrity value or authentication state that fails a policy check, or associated with a profile version not accepted for current-use execution under the active policy. In some embodiments, scale-normalization path 226 modifies, clips, transforms, or reformats the scale input before it is used by running-function generator 216. In some embodiments, cached-value path 228 bypasses one or more computations by supplying a previously verified X_opt, delta_loop, or other intermediate quantity from a cache or stored profile state. These additional paths are useful because they make the flow robust against unsupported conditions while preserving deterministic machine-level behavior.

In some embodiments, workflow 200 includes explicit rejection logic when invalid or unsupported conditions are detected. By way of example, if the selected target profile is absent or inconsistent, profile-selection decision node 222 can route execution to fallback path 224. If the requested loop order exceeds the loop-order limit of the active profile, renormalised-constant evaluator 218 can clip the loop order, reject the request, or substitute a permitted bounded order. If running-function generator 216 cannot produce a valid f_n(mu/mu_0) value for the supplied scale input, scale-normalization path 226 can clamp the scale, reject the out-of-range request, or switch to an extrapolation mode explicitly permitted by the active profile. If a verified cached intermediate is available, cached-value path 228 can bypass a runtime solve and reduce latency. These behaviors provide objective machine-level rules rather than leaving unsupported conditions to unspecified human interpretation.

In the embodiment of FIG. 3, a solver subsystem 300 is configured to determine X_opt or another minimizer or stationary-point quantity used by the disclosed computation path. The solver subsystem 300 includes an initial interval block 302, a first-derivative evaluator 304, a second-derivative evaluator 306, a third-derivative evaluator 308, an update block 310, a convergence test 312, an iteration counter 314, a converged output block 316, an exception/fallback block 318, a precision controller 320, a residual threshold input 322, a step-size threshold input 324, a monotonicity check 326, a retry path 328, a stored approximation source 330, and a hard-failure output 332. In one implementation, initial interval block 302 provides a bracket or starting estimate centered in a region expected to contain the minimizer. First-derivative evaluator 304, second-derivative evaluator 306, and third-derivative evaluator 308 compute or retrieve derivative values used by update block 310. Update block 310 applies a Newton update, Halley update, Newton-Halley hybrid update, damped update, trust-region update, or another predetermined deterministic update rule. Convergence test 312 determines whether the result meets one or more acceptance conditions. Iteration counter 314 enforces a finite iteration budget. Converged output block 316 emits the accepted estimate. Exception/fallback block 318 handles conditions such as non-convergence, oscillation, arithmetic overflow, underflow, derivative singularity, precision mismatch, or range violation. Precision controller 320 selects arithmetic format and can switch between fixed-point, floating-point, and mixed-precision modes.

In one representative solver implementation, residual threshold input 322 supplies one or more permitted residual bounds used by convergence test 312, and step-size threshold input 324 supplies one or more permitted step-size bounds used by convergence test 312. Monotonicity check 326 evaluates whether the iteration is behaving according to a monotone or otherwise allowed convergence pattern. Retry path 328 returns execution to update block 310 after a precision change, damping adjustment, or mode change. Stored approximation source 330 provides a precomputed approximation used when runtime solving is disabled, unnecessary, or unsuccessful. Hard-failure output 332 asserts when no allowed fallback remains and the active policy requires termination rather than degraded operation.

In one representative formulation, if f(X) denotes the derivative condition associated with the coverage-fit relation, update block 310 can apply a Halley-form update X_(k+1)=X_k−[2 f(X_k) f′(X_k)]/[2(f′(X_k))\hat{ }2−f(X_k) f″(X_k)]. In another implementation, a Newton step can be used. In another implementation, update block 310 uses a Newton step for the first iteration and a Halley-form step for subsequent iterations. In another implementation, update block 310 accepts a pre-verified stored estimate from stored approximation source 330 when runtime solving is disabled or unnecessary. The selection among these update behaviors can be encoded in a mode field controlled by precision controller 320 or specified by the active target profile.

In some embodiments of solver subsystem 300, convergence test 312 uses multiple acceptance criteria rather than a single scalar threshold. By way of example, convergence test 312 can require that (1) the absolute step size falls below a first threshold from step-size threshold input 324, the first threshold being not greater than 1e−6 and, in some implementations, not greater than 1e−12, (2) the residual falls below a second threshold from residual threshold input 322, the second threshold being not greater than 1e−6 and, in some implementations, not greater than 1e−12, (3) the estimate lies within an allowed interval, (4) a relative deviation between successive estimates does not exceed 1e−9, and (5) iteration counter 314 has not exceeded a maximum count of five iterations. In some embodiments, monotonicity check 326 also checks whether the iteration is behaving consistently with a selected solver mode. If any acceptance condition fails, exception/fallback block 318 can take one of several ordered actions. A representative ordered action set is: first, apply a damping factor to the next update through retry path 328 when monotonicity check 326 indicates non-monotone behavior or alternating derivative-sign behavior; second, retry through retry path 328 using a more stable arithmetic mode; third, fall back to stored approximation source 330; fourth, fall back to a profile-authorized default value; fifth, raise a recoverable fault to the host; and sixth, if the host has authorized hard failure, assert hard-failure output 332 and suppress output release. This ordered handling supports reproducibility and avoids silent undefined behavior.

In some embodiments, solver subsystem 300 is not part of the runtime critical path. Instead, X_opt is determined during manufacturing test, secure provisioning, profile compilation, first boot, scheduled recalibration, or software initialization, and the converged result is stored in protected memory. In such embodiments, converged output block 316 writes the determined value to an immutable or authenticated region, and exception/fallback block 318 can invalidate that region if later verification fails. In other embodiments, solver subsystem 300 remains callable during runtime for diagnostic, verification, or profile-refresh purposes, and a runtime-produced value is released for downstream use only if accepted under an active verification or policy state. The disclosed invention therefore supports both compute-at-runtime and compute-once-and-reuse paradigms.

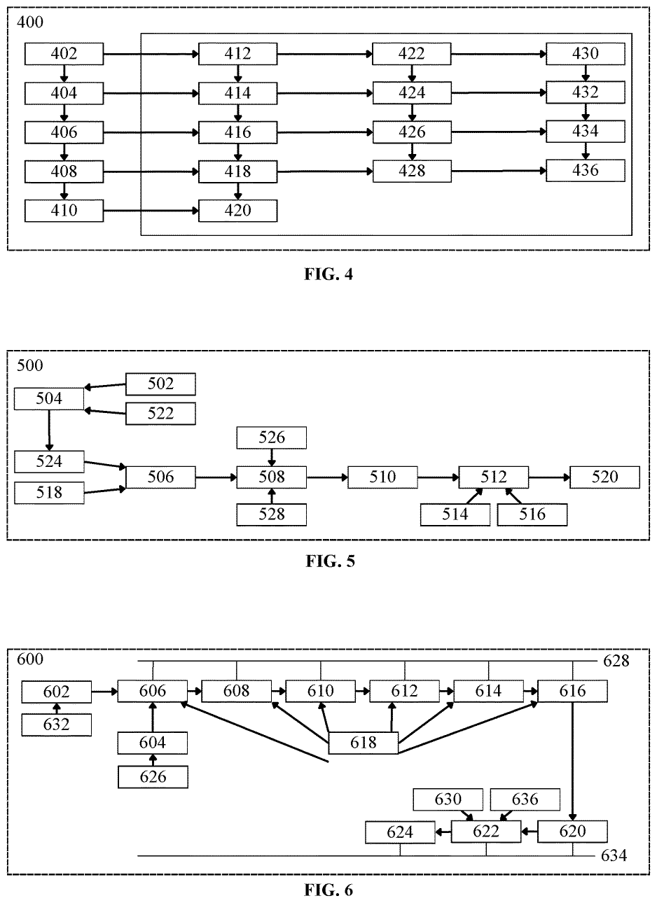

In the embodiment of FIG. 4, a target-profile data structure 400 stores target-specific execution data. The target-profile data structure 400 includes a target library 402, a target identifier 404, a first coefficient array 406, a second coefficient array 408, a reference-scale field 410, a running-function definition field 412, a loop-order limit field 414, a precision-mode field 416, a provenance field 418, a verification field 420, a target family field 422, a profile version field 424, an authentication field 426, a checksum/signature field 428, a post-processing rule field 430, an output-format field 432, a kernel-enable field 434, and an arithmetic-policy field 436. In one implementation, target library 402 stores multiple target profiles, each of which can be addressed by target identifier 404. First coefficient array 406 stores the primary series coefficients a_n used by the series engine. Second coefficient array 408 stores secondary coefficients, auxiliary coefficients, post-processing coefficients, kernel coefficients, or other target-specific parameters used by disclosed secondary transforms or fallback calculations. Reference-scale field 410 stores mu_0 or another target-specific reference quantity. Running-function definition field 412 stores definitions for one or more f_n(mu/mu_0) functions. Loop-order limit field 414 stores a maximum supported or preferred truncation depth. Precision-mode field 416 stores the arithmetic mode or allowed set of modes for the profile. Provenance field 418 stores metadata indicating profile source, derivation version, release version, timestamp, manufacturing lot, or deployment authorization. Verification field 420 stores theorem identifiers, test identifiers, bound identifiers, profile authentication data, or acceptance rules.

In some embodiments, target family field 422 identifies a constant family such as fine-structure-related, gravitational, cosmological, mass-ratio, weak-mixing, or strong-coupling. Profile version field 424 identifies a current-use version, historical version, superseded version, comparison-only version, or replay-only version of a profile. Authentication field 426 stores a token, certificate, authorization state, or other credential associated with profile acceptance. Checksum/signature field 428 stores a cryptographic checksum, digital signature, or other integrity value. Post-processing rule field 430 stores any permitted post-series transform, kernel invocation rule, or result-conditioning rule. Output-format field 432 stores a machine-output format, human-readable format, unit-conversion rule, or reporting template. Kernel-enable field 434 stores whether a selected target requires, permits, or forbids use of an optional kernel stage. Arithmetic-policy field 436 stores whether the profile permits fixed-point, floating-point, mixed-precision, reduced-precision fallback, or another arithmetic policy.

In some embodiments, the target identifier 404 is a compact integer or enumerated code. In some embodiments, target identifier 404 is a string, symbolic identifier, hashed identifier, or compound code including family and version information. In some embodiments, first coefficient array 406 is stored in read-only memory. In some embodiments, first coefficient array 406 is loaded into writable registers during initialization. In some embodiments, second coefficient array 408 is absent for profiles that do not require secondary coefficients. In some embodiments, reference-scale field 410 stores a scalar. In some embodiments, reference-scale field 410 stores a tuple, interval, or piecewise definition. In some embodiments, running-function definition field 412 stores executable code pointers, symbolic expressions, lookup-table addresses, spline data, piecewise coefficients, threshold tables, or transport-policy descriptors.

In one representative use of target-profile data structure 400, target library 402 stores profiles for a fine-structure-related target, a gravitational-constant-related target, a cosmological-constant-related target, an electron-to-proton-mass-ratio-related target, a weak-mixing-related target, a strong-coupling-related target, and additional derived targets, each profile being selectable without altering the principal architectural path through derivation engine 110, series engine 112, optional kernel engine 114, and output interface 116. Each profile can use the same derivation engine 110 and series engine 112 while differing in target identifier 404, first coefficient array 406, second coefficient array 408, reference-scale field 410, running-function definition field 412, loop-order limit field 414, precision-mode field 416, target family field 422, profile version field 424, post-processing rule field 430, output-format field 432, kernel-enable field 434, and arithmetic-policy field 436. In this manner, the disclosed system avoids requiring a separate computational engine for each target.

In some embodiments, profile selection is governed by ordered objective rules. A representative rule set is as follows. First, target selector 104 reads the requested target identifier. Second, the selector verifies that a matching profile exists in target library 402. Third, the selector confirms target family field 422 is compatible with the requested operating mode. Fourth, the selector checks profile version field 424 to determine whether the profile is current-use, historical, comparison-only, replay-only, or deprecated. Fifth, the selector verifies authentication field 426 and checksum/signature field 428. Sixth, the selector confirms that the requested arithmetic mode is permitted by precision-mode field 416 and arithmetic-policy field 436. Seventh, the selector confirms that the requested loop order does not exceed loop-order limit field 414. Eighth, the selector verifies that incoming scale input can be interpreted by running-function definition field 412. Ninth, the selector determines from kernel-enable field 434 and post-processing rule field 430 whether a kernel stage is required or permitted. Tenth, if all checks pass, the profile becomes active. If any check fails, the system applies a predetermined fallback policy including rejection, clipping, substitution of a compatible profile from the same target family and an accepted profile version, or host escalation.

In the embodiment of FIG. 5, a Sigmoid Mapping Unit 500 provides a bounded-domain mapping stage used in selected implementations. Sigmoid Mapping Unit 500 includes an input scalar block 502, a scaling block 504, a lookup table 506, an interpolation block 508, a formatter 510, an X register 512, a bypass controller 514, a latency counter 516, a calibration port 518, an output bus 520, a beta input 522, a LUT address generator 524, a LUT value output 526, and an interpolation coefficient store 528. In one implementation, input scalar block 502 receives an input g_s from the host or from an internal source. Beta input 522 receives or stores a beta value, where beta may satisfy beta=pi/phi=1/X_opt in one representative embodiment. Scaling block 504 applies beta, 2beta, or another predetermined transform to the incoming scalar. LUT address generator 524 computes an address into lookup table 506. Lookup table 506 stores sampled values of a sigmoid or related bounded mapping. LUT value output 526 emits a sampled LUT value. Interpolation block 508 refines the mapped value between sampled entries using interpolation coefficient store 528. Formatter 510 converts the resulting value into the numerical format expected by the downstream stage. X register 512 stores the mapped value. Bypass controller 514 permits the runtime path to bypass the mapping stage when a precomputed or externally supplied X value is authorized. Latency counter 516 records or enforces timing behavior. Calibration port 518 accepts values used to load, verify, or characterize lookup table 506 or interpolation coefficient store 528. Output bus 520 supplies the resulting mapped X value to a downstream stage.

In one representative implementation of Sigmoid Mapping Unit 500, the mapping is X=1/(1+exp(−2beta g_s)). In some embodiments, lookup table 506 stores 256 entries. In some embodiments, interpolation block 508 performs piecewise-linear interpolation. In some embodiments, interpolation block 508 performs polynomial interpolation, segmented interpolation, or spline interpolation. In some embodiments, formatter 510 emits a fixed-point representation. In some embodiments, formatter 510 emits a floating-point representation. In some embodiments, bypass controller 514 can bypass not only lookup table 506 but the entire Sigmoid Mapping Unit 500 so that a pre-verified X_opt stored elsewhere can be loaded directly into X register 512. In some embodiments, latency counter 516 is used for timing assurance during production test. In other embodiments, latency counter 516 is used during runtime to detect timing anomalies, performance degradation, or unauthorized mode changes.

In some embodiments, calibration port 518 is exposed only during manufacturing, validation, or authorized service modes. In some embodiments, calibration port 518 permits loading of updated lookup-table values when a new arithmetic characterization is approved. In some embodiments, calibration port 518 is read-only and is used solely to verify that lookup table 506 matches an expected authenticated image. In some embodiments, bypass controller 514 is locked out in production mode so that the system always computes the mapped value internally. In other embodiments, bypass controller 514 is accessible to permit the system to operate in a diagnostic mode, host-forced mode, software-emulation mode, or replay mode.

In the embodiment of FIG. 6, a Series-Evaluation Module 600 performs the principal bounded series computation. Series-Evaluation Module 600 includes a delta register 602, a coefficient register bank 604, a first multiply-accumulate stage 606, a second multiply-accumulate stage 608, a third multiply-accumulate stage 610, a fourth multiply-accumulate stage 612, a fifth multiply-accumulate stage 614, a sixth multiply-accumulate stage 616, a Horner controller 618, an accumulator 620, a formatter 622, an output register 624, a coefficient loader 626, a stage-valid pipeline 628, an overflow/underflow detector 630, a loop-depth selector 632, an intermediate result bus 634, and a rounding control 636. In one implementation, delta register 602 stores delta_loop. Coefficient loader 626 loads active coefficients from coefficient memory 120 or profile cache 126 into coefficient register bank 604. Loop-depth selector 632 determines the active depth N for the selected evaluation. Multiply-accumulate stages 606, 608, 610, 612, 614, and 616 implement a staged Horner-form evaluation. Horner controller 618 sequences coefficient loading, stage activation, data validity, and interstage transfer. Stage-valid pipeline 628 tracks stage-by-stage validity. Intermediate result bus 634 carries intermediate values between stages and to accumulator 620. Overflow/underflow detector 630 detects range violations. Formatter 622 applies normalization, rounding, clipping, range formatting, or representation conversion under control of rounding control 636. Output register 624 stores the result for use by downstream logic or external readout.

In one representative six-stage implementation, Series-Evaluation Module 600 evaluates C_ren=a_0+delta_loop(a_1+delta_loop(a_2+delta_loop(a_3+delta_loop(a_4+delta_loop(a_5+delta_loop a_6))))). In some embodiments, each multiply-accumulate stage corresponds to one series depth. In some embodiments, the same physical stage is reused across multiple cycles. In some embodiments, coefficient register bank 604 holds coefficients hardwired at synthesis. In some embodiments, coefficient register bank 604 is writable so that different target profiles can be activated without replacing hardware. In some embodiments, formatter 622 outputs the result in IEEE floating-point representation. In some embodiments, formatter 622 outputs a fixed-point or scaled-integer representation. In some embodiments, output register 624 stores both the result and one or more status bits indicating overflow, underflow, range clipping, convergence mode, profile identity, release eligibility for control use under an active verification or policy state, or a release-state indication identifying the result as current-use, historical-only, comparison-only, replay-only, blocked, degraded, or non-control-use.

In some embodiments, Horner controller 618 applies ordered decision rules before starting evaluation. A representative ordered sequence is as follows. First, verify that delta register 602 contains a valid value. Second, verify that coefficient register bank 604 contains an authenticated or otherwise accepted coefficient set loaded by coefficient loader 626. Third, verify through loop-depth selector 632 that the requested depth does not exceed the active profile limit. Fourth, verify that the arithmetic mode requested by the host is permitted by the active profile. Fifth, begin evaluation at the deepest enabled term. Sixth, propagate intermediate results through multiply-accumulate stages 616, 614, 612, 610, 608, and 606 or their logical equivalents while stage-valid pipeline 628 confirms interstage validity. Seventh, monitor overflow/underflow detector 630. Eighth, write the final result into accumulator 620. Ninth, apply formatter 622 and rounding control 636. Tenth, store the result in output register 624. Eleventh, assert a completion indication if no blocking error is present. This execution policy supports objective implementation and reduces ambiguity during later claim interpretation.

In some embodiments, Series-Evaluation Module 600 uses bounded truncation rules linked to the magnitude of delta_loop. Because delta_loop is less than one in representative embodiments, the contribution of later terms can decrease in magnitude under appropriate coefficient structures, which supports bounded-order implementation without indefinite runtime expansion. In some embodiments, the active profile specifies a mandatory maximum N. In some embodiments, the active profile specifies a preferred N and one or more permissible lower-N fallback modes, and formatter 622 or output register 624 stores metadata identifying whether the reported result was produced at the preferred N or at one of the permissible lower-N fallback modes, together with an indication of whether the reported result remains eligible for control use under the active verification or policy state. In some embodiments, formatter 622 reports which N value was actually used so that downstream users can distinguish between a full-depth result and a fallback result, and in some embodiments also reports whether the result is eligible for control use under an active verification or policy state.

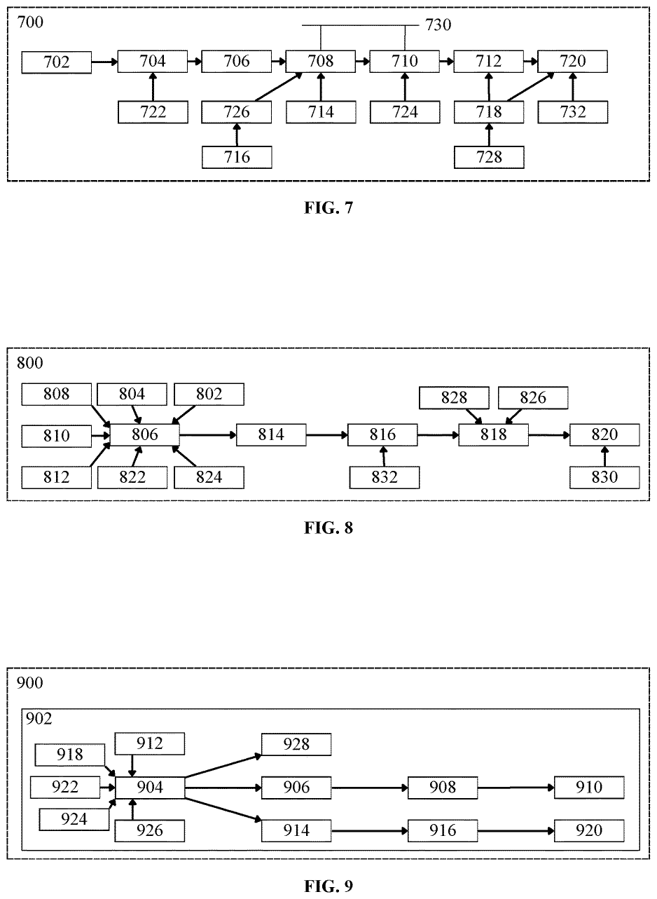

In the embodiment of FIG. 7, a Fractional-Kernel Engine 700 provides an optional secondary transform path. Fractional-Kernel Engine 700 includes a kernel enable input 702, a spatial input buffer 704, a forward transform block 706, a spectral multiplier 708, an inverse transform block 710, a gravity-potential output block 712, an exponent parameter register 714, a kernel memory 716, a bypass multiplexer 718, an output buffer 720, a kernel mode selector 722, a transform-length selector 724, a coefficient fetch path 726, a bypass-valid signal 728, a transformed-data bus 730, and a kernel-status flag 732. In one implementation, kernel enable input 702 selects whether the optional kernel path is active. Kernel mode selector 722 selects among permitted transform or kernel modes. Transform-length selector 724 selects a transform size or transform policy. Spatial input buffer 704 accepts spatial-domain data, field samples, simulation values, or another input representation suitable for transform processing. Forward transform block 706 maps the input into a transform domain. Coefficient fetch path 726 retrieves kernel coefficients or factors from kernel memory 716. Spectral multiplier 708 multiplies transform-domain values by a kernel or exponent-dependent factor. Exponent parameter register 714 stores an exponent or kernel descriptor. Inverse transform block 710 returns the transformed representation to a spatial or output domain. Gravity-potential output block 712 produces a transformed output, including in one example a gravity-related output. Bypass multiplexer 718 permits the engine to be bypassed when the active target does not require secondary transform processing. Bypass-valid signal 728 indicates that a bypassed result is valid under the selected operating mode. Transformed-data bus 730 carries transformed values through the kernel path. Output buffer 720 stores the resulting output. Kernel-status flag 732 indicates the kernel mode, completion state, or fault state of the engine.

In one representative gravity-related embodiment, Fractional-Kernel Engine 700 supports a potential relation V_grav(r)=−G_ren M/r\hat{ }(1+2·5/12), which is equivalent to V_grav(r)=−G_ren M/r\hat{ }(1+5/6), with a transform-domain multiplier proportional to magnitude(k)\hat{ }(5/6) in one spectral implementation. In some embodiments, forward transform block 706 and inverse transform block 710 implement an FFT of fixed length, such as 64 points selected by transform-length selector 724. In some embodiments, other transform lengths are used. In some embodiments, spectral multiplier 708 uses coefficients read from kernel memory 716 through coefficient fetch path 726. In some embodiments, exponent parameter register 714 stores a single exponent value and spectral multiplier 708 computes kernel factors on demand. In some embodiments, bypass multiplexer 718 is controlled by the active target profile. In some embodiments, bypass multiplexer 718 is controlled by an explicit host flag, but only if the selected profile allows kernel bypass.

In some embodiments, Fractional-Kernel Engine 700 supports more than gravity-related processing. By way of example, the engine can apply another target-specific spectral transform, post-series correction, field-domain transport, or kernelized post-processing step so long as such step is authorized by the active profile and implemented according to the disclosed machine-level rules. In some embodiments, kernel mode selector 722 selects among multiple target-specific kernel classes. In some embodiments, transform-length selector 724 also indicates whether the transform is fixed, adaptive, or profile-governed. In some embodiments, transformed-data bus 730 carries metadata in addition to numerical values. In some embodiments, kernel-status flag 732 is exposed to status block 818 for integrated control handling.

In the embodiment of FIG. 8, a control and timing subsystem 800 governs machine-level sequencing. Control and timing subsystem 800 includes a clock input 802, a reset input 804, a stage scheduler 806, a first valid line 808, a second valid line 810, a third valid line 812, a latency counter 814, a power controller 816, a status block 818, a completion flag 820, a fixed-latency mode input 822, a variable-latency mode input 824, a blocking-fault flag 826, a recoverable-fault flag 828, a stage-enable output 830, and a clock-gate control 832. Stage scheduler 806 coordinates the timing of upstream and downstream blocks. In one representative implementation, first valid line 808 corresponds to the validity of an output from Sigmoid Mapping Unit 500 or equivalent preprocessing stage, second valid line 810 corresponds to the validity of an output from Series-Evaluation Module 600, and third valid line 812 corresponds to the validity of an output from Fractional-Kernel Engine 700. Latency counter 814 records elapsed cycles and can be used for compliance with a fixed-latency or bounded-latency policy. Power controller 816 can gate clocks, disable unused blocks, or place selected logic into reduced-power states. Status block 818 stores faults, warnings, completion states, arithmetic-mode states, or profile states. Completion flag 820 signals that an output is ready or that a completed state has otherwise been reached.

In some embodiments, fixed-latency mode input 822 causes stage scheduler 806 to maintain a predetermined total cycle count even when the optional kernel stage is bypassed. In some embodiments, variable-latency mode input 824 causes completion flag 820 to be asserted as soon as a valid result is available. Blocking-fault flag 826 is asserted when a result must not be released. Recoverable-fault flag 828 is asserted when a degraded but policy-authorized result may still be produced. Stage-enable output 830 drives enablement of one or more processing stages according to the current schedule and mode. Clock-gate control 832 cooperates with power controller 816 to reduce power consumption in idle or bypassed regions.

In some embodiments, stage scheduler 806 uses ordered gating logic that only advances a value to a downstream stage when all of the following are true: the upstream valid line is asserted, the downstream stage is enabled through stage-enable output 830, no blocking fault is present in status block 818 or blocking-fault flag 826, reset input 804 is inactive, the selected timing policy indicated by fixed-latency mode input 822 or variable-latency mode input 824 permits the transition in the current cycle, and the active profile remains authenticated and within its permitted arithmetic-policy state. In some embodiments, a soft fault such as a recoverable profile mismatch may be reflected in recoverable-fault flag 828 without suppressing completion if a fallback output is permitted. In other embodiments, any fault classified as blocking suppresses completion flag 820 and prevents output release. These objective rules make the control consequences of runtime conditions concrete.

In the embodiment of FIG. 9, an integrated-circuit embodiment 900 provides one representative physical packaging of the disclosed architecture. Integrated-circuit embodiment 900 includes a package substrate 902, a renormalisation core 904, an external interface 906, a host processor 908, a memory 910, a sensor or external-source input 912, an interconnect 914, a power-management block 916, a thermal sensor 918, an external output device 920, a control register block 922, a target register block 924, a scale register block 926, and a result register block 928. In one implementation, renormalisation core 904 includes one or more of derivation engine 110, series engine 112, optional kernel engine 114, and control circuitry associated with control and timing subsystem 800. External interface 906 can be register-mapped, message-based, packet-based, memory-mapped, serial, parallel, interrupt-driven, DMA-capable, or implemented according to another protocol. Host processor 908 issues commands and receives results. Memory 910 stores coefficient data, profile data, cached derived values, firmware state, or host-visible registers. Sensor or external-source input 912 provides an external scale value or application-specific input. Interconnect 914 couples integrated-circuit embodiment 900 to the broader system. Power-management block 916 supervises supply behavior. Thermal sensor 918 provides temperature monitoring. External output device 920 can be a display, communication interface, storage subsystem, controller input, simulator interface, or other consumer of the result.

In some embodiments, control register block 922 stores execution-control bits, mode bits, or start/stop signals. Target register block 924 stores a requested target identifier or profile-selection input. Scale register block 926 stores one or more incoming scale values. Result register block 928 stores the computed output, output status, or associated provenance bits. In some embodiments, host processor 908 writes a target identifier to target register block 924, writes a scale value to scale register block 926, writes a mode or start bit to control register block 922, and then polls or waits on an interrupt associated with completion flag 820 before reading result register block 928. In some embodiments, result register block 928 stores both a numerical result and a status class, and in some embodiments further stores at least one of a verification state, a profile-version identifier, an integrity-related metadata field associated with the active profile or executable state, a release-eligibility state for control use, or an indication that the result is current-use, historical-only, comparison-only, replay-only, blocked, degraded, or non-control-use.

In some representative semiconductor implementations, renormalisation core 904 is fabricated in a low-power CMOS process and clocked at a frequency selected to support bounded-latency operation. In one example, a six-loop implementation can be configured for a total latency of thirty-eight cycles under an approximately 800 MHz clock. In one example, the integrated circuit can be implemented with a nominal supply voltage of about 0.75 V and a compact die footprint. These values are exemplary and do not limit the broader invention.

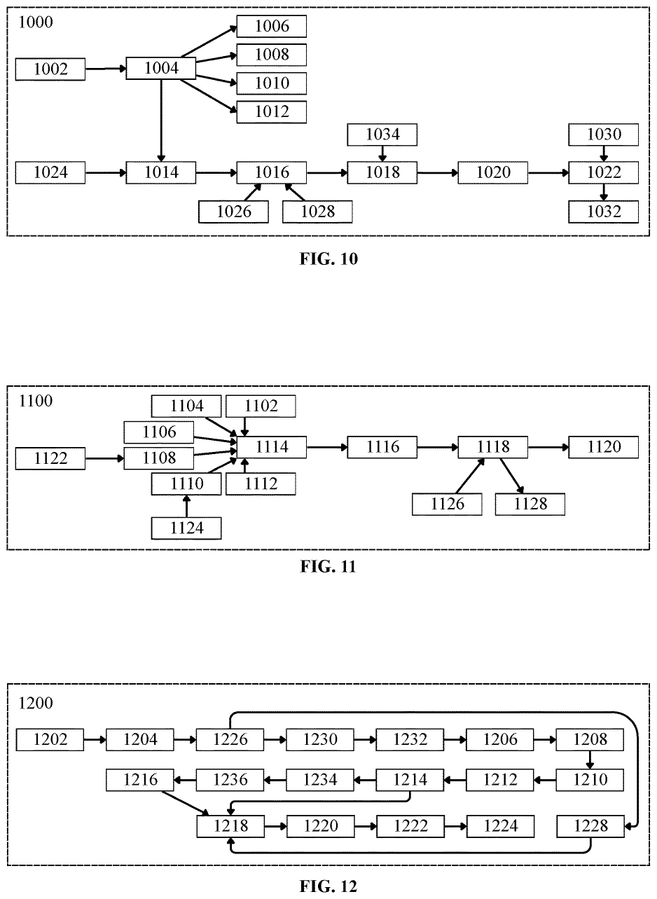

In the embodiment of FIG. 10, a software-stack embodiment 1000 provides a software deployment of the same architecture. Software-stack embodiment 1000 includes an API layer 1002, a C++ library 1004, a Python binding 1006, a Rust binding 1008, a MATLAB binding 1010, a Julia binding 1012, a simulation plug-in 1014, a deterministic-build module 1016, a verification module 1018, a user application 1020, a result log 1022, a profile repository 1024, a build manifest 1026, a checksum store 1028, a replay module 1030, an audit export path 1032, and a hardware equivalence checker 1034. In one implementation, API layer 1002 exposes a function that accepts a target identifier, scale input, and optional loop-order input, and returns a computed output together with at least one status indicator, verification indicator, profile identifier, or release-state indicator corresponding to the computation that produced the output. C++ library 1004 provides a core implementation. Python binding 1006, Rust binding 1008, MATLAB binding 1010, and Julia binding 1012 provide language-specific interfaces. Simulation plug-in 1014 integrates the computation into a simulator or workflow engine. Deterministic-build module 1016 stores or enforces build settings, artifact checksums, compiler policies, and reproducibility settings. Verification module 1018 performs profile validation, arithmetic checks, theorem-linked validation, or runtime consistency checks. User application 1020 consumes the service. Result log 1022 stores output records, metadata, audit data, or release-state data indicating whether a stored result is current-use, historical-only, comparison-only, replay-only, blocked, degraded, or non-control-use.

In some embodiments, profile repository 1024 stores current-use profiles, historical profiles, comparison-only profiles, replay-only profiles, test profiles, or remote-synchronized profiles. Build manifest 1026 stores a build identity that can be associated with a specific profile set, compiler version, dependency set, or release bundle. Checksum store 1028 stores integrity values associated with executable artifacts, profile artifacts, or output bundles. Replay module 1030 re-executes one or more prior computations using stored profiles and inputs to reproduce a result or confirm consistency, and in some embodiments records whether the replayed result is designated as historical-only, comparison-only, replay-only, non-control-use, or acceptable for current-use policy evaluation. Audit export path 1032 emits metadata, computation records, or validation records to an external archive, compliance endpoint, or test harness. Hardware equivalence checker 1034 compares a software result path against a hardware result path to confirm cross-implementation consistency.

In some embodiments, API layer 1002 provides a call having the form rp::renorm(target, mu, loop_order)→value, and the returned value is accompanied in memory or an associated object by at least one status indicator, verification indicator, profile identifier, or release-state indicator corresponding to the computation that produced the returned value. In some embodiments, API layer 1002 also accepts an execution mode, reporting mode, kernel flag, profile version, arithmetic mode, or validation mode. In some embodiments, simulation plug-in 1014 integrates with molecular-dynamics software, collider event generation software, metrology software, navigation software, edge inference software, or batch-processing software. In some embodiments, deterministic-build module 1016 emits or verifies build manifest 1026 and checksum store 1028 before execution proceeds. In some embodiments, replay module 1030 uses result log 1022 and profile repository 1024 to reproduce a prior result using the same target-profile identifier, profile version, arithmetic mode, loop-order setting, and checksum-identified artifact state that were associated with the prior result, and stores the reproduced result with a historical-only, comparison-only, replay-only, or non-control-use state unless separately reauthorized under an active policy state. In some embodiments, hardware equivalence checker 1034 confirms that a computation performed by C++ library 1004 matches a result obtained from integrated-circuit embodiment 900.

In the embodiment of FIG. 11, a deployment environment 1100 illustrates representative use contexts. Deployment environment 1100 includes a gravimeter embodiment 1102, a molecular-dynamics embodiment 1104, a collider-simulation embodiment 1106, an edge-AI embodiment 1108, a spacecraft-navigation embodiment 1110, a scale input 1112, a renormalised-constant output 1114, a control loop 1116, a comparison block 1118, a diagnostic output 1120, a local execution path 1122, a remote execution path 1124, a baseline/reference source 1126, and an alert output 1128. In one implementation, gravimeter embodiment 1102 receives a local scale input derived from a measurement state and uses renormalised-constant output 1114 as an input to a gravity-related model or correction path. In one implementation, molecular-dynamics embodiment 1104 receives a scale input 1112 derived from local or global simulation conditions and uses renormalised-constant output 1114 to update a simulation parameter or force-related quantity. In one implementation, collider-simulation embodiment 1106 receives a scale input associated with a simulated interaction and uses output 1114 in an event generator or cross-section-related computation. In one implementation, edge-AI embodiment 1108 uses the result as a deterministic machine parameter, scaling parameter, or physical-model parameter within an inference or embedded-compute context. In one implementation, spacecraft-navigation embodiment 1110 uses the output in a trajectory or gravity model.

In some embodiments, local execution path 1122 represents a local hardware or software path that executes the computation on-device, while remote execution path 1124 represents a remote or distributed service path. Baseline/reference source 1126 provides a comparison value, expected range, reference implementation, or measured quantity to comparison block 1118. Diagnostic output 1120 provides a signal indicating agreement, deviation, threshold crossing, anomaly, or mode state. Alert output 1128 is emitted when comparison block 1118 or control loop 1116 detects a condition requiring external attention, policy intervention, or degraded operation handling. In some embodiments, control loop 1116 consumes renormalised-constant output 1114 directly, without human intervention, only when the output is accompanied by a verification, policy, or release-state indication identifying the output as eligible for control use under the active profile and operating mode. In some embodiments, comparison block 1118 distinguishes between historical records and current-use records, and further distinguishes comparison-only records and replay-only records, such that archived outputs are not automatically used for control. In some embodiments, comparison block 1118 distinguishes between presentation-only changes and machine-significant computational changes, thereby preventing display-only updates or blocked, degraded, or non-control-use outputs from triggering recalibration or control actions.

In some embodiments, deployment environment 1100 supports local execution, remote execution, offline execution, online execution, batch execution, streaming execution, and hybrid execution. By way of example, a local embedded controller may execute integrated-circuit embodiment 900 on-device through local execution path 1122, while a cloud service uses software-stack embodiment 1000 through remote execution path 1124 to precompute or validate outputs. In another example, a simulator may call C++ library 1004 directly during batch execution while a field instrument uses a fixed-latency hardware path, each path preserving machine-actionable output formatting that includes at least one status, verification, profile-identification, or release-state field. The underlying computational structure remains the same even though packaging, scheduling, and deployment differ.

In the embodiment of FIG. 12, a method flow 1200 provides one representative machine-level sequence. Method flow 1200 includes a target-receive step 1202, a scale-receive step 1204, an X_opt determination step 1206, an R_RP determination step 1208, a delta_loop determination step 1210, a target-profile load step 1212, a series-evaluation step 1214, an optional-kernel step 1216, an output-generation step 1218, a store-or-transmit step 1220, a verification step 1222, an end state 1224, a profile-validation branch 1226, a fallback branch 1228, a cache-hit branch 1230, a cache-miss branch 1232, a kernel-bypass branch 1234, and a kernel-enabled branch 1236. In one representative execution, target-receive step 1202 accepts a requested output target. Scale-receive step 1204 accepts a scale input. Profile-validation branch 1226 determines whether the requested target can be served by an accepted profile. If profile validation fails, fallback branch 1228 is entered. If a previously verified intermediate is available, cache-hit branch 1230 is entered and the flow can bypass at least part of X_opt determination step 1206 or delta_loop determination step 1210. If no such intermediate is available, cache-miss branch 1232 is entered and the flow performs runtime determination. Target-profile load step 1212 activates the corresponding profile. Series-evaluation step 1214 performs bounded series evaluation. If the profile does not require kernel processing, kernel-bypass branch 1234 is followed. If the profile requires kernel processing, kernel-enabled branch 1236 is followed to optional-kernel step 1216. Output-generation step 1218 formats the output. Store-or-transmit step 1220 writes, transmits, or otherwise exposes the result. Verification step 1222 checks one or more validation conditions. End state 1224 indicates completion.

In some embodiments, the order shown in method flow 1200 can be modified. For example, target-profile load step 1212 can occur before X_opt determination step 1206 if the profile determines whether a runtime solve is necessary. In some embodiments, R_RP determination step 1208 and delta_loop determination step 1210 can be skipped when cache-hit branch 1230 is taken. In some embodiments, verification step 1222 can occur both before and after output-generation step 1218. In some embodiments, store-or-transmit step 1220 occurs only if verification passes, and otherwise the method stores the result together with a blocked, degraded, historical-only, comparison-only, replay-only, or non-control-use state indication without releasing the result for control use. In some embodiments, fallback branch 1228 can lead to a reduced-fidelity result when the active policy authorizes degraded operation, and the reduced-fidelity result is tagged with a degraded or non-control-use state unless separately accepted for control use under the active policy. In some embodiments, end state 1224 distinguishes among success, degraded success, recoverable failure, and blocking failure.

In one representative end-to-end example, a host writes a target corresponding to a fine-structure-related output to input interface 102, writes a scale value to scale input block 106, and selects a bounded loop order through loop-order input block 108. Target selector 104 activates a corresponding target profile in target library 402. Derivation engine 110 retrieves or computes X_opt and delta_loop, using cached-value path 228 if available. Coefficient-set selector 214 loads coefficients into coefficient register bank 604 through coefficient loader 626. Running-function generator 216 produces f_n(mu/mu_0). Series-Evaluation Module 600 evaluates the bounded series through stages 606-616 under control of Horner controller 618. Formatter 622 normalizes the result and stores it in output register 624 and optionally result register 128. Output interface 116 exposes the result to host device 118. If the active profile does not require kernel processing, optional kernel engine 114 is bypassed through bypass multiplexer 718 or by stage scheduler 806 policy, and kernel-bypass branch 1234 applies, with the resulting output being releasable for control use only if accompanied by a verification or policy state permitting such release. Completion flag 820 is then asserted in accordance with the selected timing policy.

In another representative example, a gravity-related target is requested. Target selector 104 activates a gravity-related profile stored in target library 402. Derivation engine 110 computes or retrieves the shared intermediate values. Series engine 112 computes a renormalised quantity used by the gravity-related path. Optional kernel engine 114 is enabled via kernel enable input 702 and kernel-enabled branch 1236 applies. Spatial input buffer 704 receives field data or another spatial-domain quantity. Forward transform block 706 transforms the input. Spectral multiplier 708 multiplies by factors based on exponent parameter register 714, kernel mode selector 722, transform-length selector 724, coefficient fetch path 726, and kernel memory 716. Inverse transform block 710 reconstructs a transformed-domain output. Gravity-potential output block 712 provides the resulting value, which is then stored in output buffer 720 and released by output interface 116. Control and timing subsystem 800 either preserves fixed total latency or asserts completion when the kernel stage has finished, depending on the selected policy.

In some embodiments, the disclosed system distinguishes carefully among storage, validation, verification, policy acceptance, control use, and current-use authorization status. Writing a value into output register 624, result register 128, result register block 928, or result log 1022 does not by itself mean that the value has been accepted for control use. A result may be stored for later analysis while verification step 1222 is still pending. Likewise, a profile may be authenticated through authentication field 426, checksum/signature field 428, provenance field 418, and verification field 420 without yet being accepted by a deployment policy. In some embodiments, verification module 1018 proves that a result is internally consistent, while a separate policy engine or host application decides whether that result should actually drive a gravimeter, simulator, navigation loop, or inference engine.

In some embodiments, the disclosed system distinguishes between human-readable outputs and machine-actionable outputs, and the machine-actionable outputs are formatted to preserve at least a numerical value together with one or more of status, verification, profile-version, integrity, or release-state fields for downstream automated consumption. A human-readable output may include rounded numbers, labels, or explanatory formatting intended for display or documentation according to output-format field 432. A machine-actionable output may include a binary value, register payload, signed packet, or structured data object consumed by downstream software or hardware. In some embodiments, output-generation step 1218 produces both forms, and the machine-actionable form is generated first and is the form subjected to verification and control-use policy handling before any human-readable rendering is emitted, the machine-actionable form including at least one status, verification, profile-version, integrity, or release-state field. In some embodiments, only the machine-actionable form is produced during runtime, and a human-readable form is generated later.

In some embodiments, the disclosed system also distinguishes current-use data from historical data, comparison-only data, and replay-only data. A current-use profile is one that is currently authorized and active for runtime evaluation. A historical profile is one retained for audit or replay. A comparison-only profile is one retained for non-operational comparison use and is not authorized for current-use execution unless separately reauthorized under an active policy state. A replay-only profile is one retained for reproduction of prior computations without current-use authorization. A current-use result is one produced under the active policy for operational use and accompanied by a release state permitting current-use deployment. A historical result may be retained in result log 1022 or profile repository 1024 for comparison or traceability. A comparison-only or replay-only result is not authorized for current-use control deployment unless separately reauthorized under an active policy state. In some embodiments, profile version field 424 includes a profile activation interval, deactivation state, supersession marker, comparison-only marker, or replay-only marker so that replayed computations can be correctly identified as historical rather than operational. This explicit treatment supports audit, reproducibility, version control, and regulated deployment.

In some embodiments, the disclosed system supports remote, distributed, or service-based execution. For example, target library 402 and running-function definition field 412 may be hosted in a remote authenticated repository such as profile repository 1024, while a local hardware device performs only bounded series evaluation. In another example, derivation engine 110 executes remotely and provisions X_opt and delta_loop to a local integrated-circuit embodiment 900. In another example, profiles are signed remotely and synchronized to memory 910, coefficient memory 120, or profile cache 126. In some embodiments, a distributed embodiment preserves the same ordered activation and validation rules described above so that local and remote deployments remain behaviorally consistent, including consistent handling of profile acceptance, fallback invocation, verification outcome, and release or non-release for control use.

In some embodiments, the disclosed system supports CI/CD, manufacturing, regulatory, or verification workflows. By way of example, deterministic-build module 1016 can ensure that a given profile set and software image compile reproducibly. Build manifest 1026 and checksum store 1028 can record or verify the exact profile and build state. Verification field 420 can store theorem identifiers or bounded proof references establishing one or more properties such as positivity, boundedness, deterministic behavior, or timing limits. Manufacturing test can use calibration port 518, latency counter 516, latency counter 814, thermal sensor 918, and status block 818 to validate device behavior. Hardware equivalence checker 1034 can confirm that a hardware result path matches a software result path. Audit export path 1032 can transmit records to an external archive or compliance environment.

In some embodiments, the disclosed architecture is implemented entirely in hardware. In some embodiments, it is implemented entirely in software. In some embodiments, it is split such that derivation engine 110 and verification logic execute in software, while series engine 112 and optional kernel engine 114 execute in hardware. In some embodiments, preprocessing occurs in software, bounded series evaluation occurs on an ASIC, and audit logging occurs remotely. In some embodiments, the same target profile can be used in all such implementations. This flexibility does not undermine determinism because the operational rules, profile constraints, and activation logic remain defined and objective.

In some embodiments, the disclosed invention includes one or more fallback embodiments. A first fallback embodiment omits optional kernel engine 114 entirely. A second fallback embodiment stores X_opt and delta_loop rather than solving at runtime. A third fallback embodiment uses a reduced loop order when the requested loop order is unsupported or when a degraded mode is authorized. A fourth fallback embodiment performs the computation in software when a hardware accelerator is absent or unavailable. A fifth fallback embodiment uses fixed-point arithmetic for Sigmoid Mapping Unit 500 and floating-point arithmetic for Series-Evaluation Module 600. A sixth fallback embodiment disables some metadata fields in resource-constrained devices while retaining the same core series architecture. These fallback embodiments are disclosed to provide robust written-description support and are not admissions that any omitted feature is required in every claim.

In some embodiments, the disclosed invention also includes variations directed to security and integrity. For example, authentication field 426, checksum/signature field 428, provenance field 418, and verification field 420 can store digital signatures, checksums, monotonic version counters, tamper-evidence markers, or policy tokens. In some embodiments, external interface 906 only accepts profile updates when an authenticated token is present. In some embodiments, coefficient register bank 604 becomes write-locked after activation. In some embodiments, result log 1022 is append-only. In some embodiments, status block 818 records attempted unauthorized mode changes. These features can be useful where the renormalised output affects control behavior, calibration, safety, or regulated operation.

In some embodiments, the disclosed system supports thresholds, classifications, and operating states that may later be recited in claims, including distinctions among current-use, historical-only, comparison-only, replay-only, blocked, degraded, and non-control-use states. By way of example, the system can classify profiles as full-fidelity, reduced-fidelity, debug-only, historical, comparison-only, replay-only, production-authorized, or deprecated using target family field 422, profile version field 424, verification field 420, and status block 818. The system can classify arithmetic modes as fixed-point, floating-point, or mixed precision using precision-mode field 416 and arithmetic-policy field 436. The system can classify results as valid, degraded-valid, unverified, blocked, historical, comparison-only, replay-only, or non-control-use using result register 128, result register 624, result register block 928, and status block 818. The system can classify inputs as in-range, clamped, extrapolated, or unsupported using scale-normalization path 226, comparison block 1118, and diagnostic output 1120. These objective classifications help avoid unsupported functional language and provide a concrete basis for later prosecution-oriented claim drafting.

The disclosed embodiments are illustrative and not limiting. No feature described in connection with one embodiment is required in every embodiment unless expressly stated. No equation, target family, hardware metric, software package, protocol, fabrication parameter, operating frequency, arithmetic mode, transform length, profile format, or deployment environment described herein should be construed as limiting unless expressly recited in a claim. The disclosed figures are limited to FIGS. 1-12, and no additional figures are required to practice the invention. A person of ordinary skill in the art, having the benefit of this disclosure, will recognize that modifications, substitutions, combinations, rearrangements, and equivalents can be used without departing from the inventive concepts set forth herein.

1. A computer-implemented method for deterministically computing a renormalised physical constant, the method comprising: receiving, by a computing system, a target identifier corresponding to a selected target constant; receiving, by the computing system, a scale input corresponding to a selected computational scale; determining, by the computing system, a coverage-fit minimizer X_opt; determining, by the computing system, a loop correction ratio R_RP and a loop correction parameter delta_loop based at least in part on X_opt; loading, by the computing system, a target profile associated with the target identifier, the target profile comprising (i) a coefficient set including a plurality of coefficients a_n, (ii) a reference-scale definition, and (iii) one or more running-function definitions; evaluating, by the computing system, a bounded renormalisation series using the coefficient set, delta_loop, the scale input, and the one or more running-function definitions under a bounded-latency staged multiply-accumulate schedule to generate a renormalised output corresponding to the selected target constant; outputting, by the computing system, a machine-actionable representation of the renormalised output together with at least one status, verification, profile-identification, or release-state field; and excluding, between determining delta_loop and outputting the machine-actionable representation, insertion of empirically selected counter-terms or scheme-conversion parameters into intermediate computational stages.

2. The method of claim 1, wherein determining X_opt comprises solving a derivative condition associated with a coverage-fit relation using a Newton iteration, a Halley iteration, or a Newton-Halley hybrid iteration under a finite iteration budget and subject to a convergence test including a residual bound, a step-size bound, and an interval-validity condition.

3. The method of claim 1, wherein determining X_opt comprises retrieving a previously stored verified value of X_opt from memory, the memory comprising an authenticated, immutable, or otherwise accepted storage region, and reusing the previously stored verified value for a plurality of target evaluations.

4. The method of claim 1, wherein determining X_opt comprises determining X_opt as phi/pi, wherein determining R_RP comprises determining R_RP as 7/12, and wherein determining delta_loop comprises computing delta_loop as X_opt raised to a power of 1+R_RP.

5. The method of claim 1, wherein evaluating the bounded renormalisation series comprises evaluating C_ren(mu)=sum from n=0 to N of a_n*delta_loop\hat{ }n*f_n(mu/mu_0), where mu corresponds to the scale input, mu_0 corresponds to the reference-scale definition, and f_n(mu/mu_0) corresponds to the one or more running-function definitions.

6. The method of claim 1, wherein loading the target profile comprises verifying that the target profile satisfies a loop-order limit and a precision-mode requirement before evaluating the bounded renormalisation series, verifying that an incoming scale input is interpretable by the one or more running-function definitions, and verifying an authentication state or integrity value associated with the target profile before activating the target profile, and wherein the one or more running-function definitions comprise at least one of a lookup table with interpolation coefficients, a piecewise polynomial or spline approximation, or an analytic expression executable by the computing system.

7. The method of claim 1, further comprising applying, after evaluating the bounded renormalisation series, an optional kernel transform to spatial-domain samples stored in a spatial input buffer or to transformed-domain samples generated therefrom, responsive to the target profile indicating that kernel processing is enabled, wherein applying the optional kernel transform comprises performing a forward transform on the spatial-domain samples, applying a spectral-domain multiplier based on an exponent parameter, and performing an inverse transform to generate a transformed output.

8. The method of claim 7, wherein applying the optional kernel transform comprises applying a spectral-domain multiplier corresponding to a fractional exponent and, in a gravity-related embodiment, corresponding to a transform-domain multiplier proportional to magnitude(k)\hat{ }(5/6).

9. The method of claim 1, further comprising, before outputting the machine-actionable representation, performing a verification operation comprising computing an acceptance metric corresponding to at least one of a range check, a convergence check, a profile-authentication check, or an arithmetic-mode check, and accepting the renormalised output for control use only when the acceptance metric satisfies at least one threshold associated with the target profile or an active policy state, the at least one threshold comprising an absolute residual not exceeding 1e−6, a relative deviation not exceeding 1e−9, a verified profile-authentication state, or a permitted arithmetic-mode state.

10. The method of claim 1, wherein outputting the machine-actionable representation comprises writing the renormalised output, together with at least one status or verification field and, in some embodiments, a release-eligibility state for control use, to a register, a memory location, a message buffer, or a structured data object consumable by a host device without human reinterpretation, the machine-actionable representation further indicating, in some embodiments, whether the output is current-use, historical-only, comparison-only, replay-only, blocked, degraded, or non-control-use.

11. The method of claim 1, wherein the selected target constant is selected from a fine-structure-related quantity, a gravitational-constant-related quantity, a cosmological-constant-related quantity, an electron-to-proton-mass-ratio-related quantity, a weak-mixing-related quantity, or a strong-coupling-related quantity, and wherein the target profile associated with the selected target constant specifies at least one reference-scale definition, running-function definition, arithmetic-policy constraint, and verification condition or kernel-enable condition for that selected target constant.

12. A renormalisation system for deterministically computing a renormalised physical constant, the renormalisation system comprising: an input interface configured to receive a target identifier and a scale input; a derivation engine configured to determine a coverage-fit minimizer X_opt, a loop correction ratio R_RP, and a loop correction parameter delta_loop; a memory storing a target profile associated with the target identifier, the target profile comprising (i) a coefficient set including a plurality of coefficients a_n, (ii) a reference-scale definition, and (iii) one or more running-function definitions; a series-evaluation engine configured to evaluate a bounded renormalisation series using the coefficient set, delta_loop, the scale input, and the one or more running-function definitions under a bounded-latency execution policy to generate a renormalised output corresponding to a selected target constant; control circuitry configured to schedule the derivation engine and the series-evaluation engine, to enforce a stage-valid or execution-valid condition for release of the renormalised output, and to block release of the renormalised output when a blocking fault or failed verification state is present; and an output interface configured to provide, to a host device, a machine-actionable representation of the renormalised output together with at least one status field, verification field, profile-identification field, or release-state field.

13. The renormalisation system of claim 12, further comprising a target selector configured to activate the target profile based on the target identifier after verifying that the target profile satisfies at least a profile-authentication condition, an integrity condition, an arithmetic-policy compatibility condition, and a loop-order compatibility condition, after confirming that a checksum value or signature value associated with the target profile matches an accepted integrity record, after confirming that an incoming scale input is interpretable by the one or more running-function definitions of the target profile, and after confirming that the target profile is authorized for current-use execution under an active policy state.

14. The renormalisation system of claim 12, wherein the derivation engine comprises a solver subsystem including an initial interval block, an update block configured to apply a Newton iteration, a Halley iteration, or a Newton-Halley hybrid iteration, a convergence test, a monotonicity check, a retry path, a stored approximation source, an iteration counter, and an exception or fallback block.

15. The renormalisation system of claim 12, wherein the series-evaluation engine comprises a delta register, a coefficient register bank, a plurality of multiply-accumulate stages arranged to perform Horner-form staged multiply-accumulate evaluation of the bounded renormalisation series, a Horner controller, an accumulator, an overflow or underflow detector, a loop-depth selector, a stage-valid pipeline, a formatter, and an output register.

16. The renormalisation system of claim 12, further comprising an optional kernel engine configured to apply a secondary transform after evaluation of the bounded renormalisation series for a target profile that requires kernel processing, the optional kernel engine comprising a spatial input buffer, a forward transform block, a spectral multiplier, an exponent parameter register, a kernel memory, an inverse transform block, a bypass multiplexer, and a kernel-status flag.

17. The renormalisation system of claim 12, further comprising a control and timing subsystem configured to enforce a bounded-latency execution policy for the derivation engine and the series-evaluation engine, the control and timing subsystem comprising a stage scheduler, a latency counter, a status block, a blocking-fault flag, a stage-enable output, and a completion flag.

18. The renormalisation system of claim 17, wherein the control and timing subsystem is configured to enforce a fixed-latency execution policy even when an optional kernel engine is bypassed, using a stage scheduler responsive to a fixed-latency mode input, a stage-enable output, and a completion flag asserted after a predetermined cycle count tracked by the latency counter, and wherein the control and timing subsystem suppresses assertion of the completion flag when a blocking fault is present or when the active profile fails an authentication or integrity check.

19. A non-transitory computer-readable medium storing instructions that, when executed by one or more processors, cause the one or more processors to perform the method of claim 1, including loading the target profile, evaluating the bounded renormalisation series, performing the verification operation, outputting the machine-actionable representation of the renormalised output, and suppressing release of the machine-actionable representation for control use when the verification operation fails or when the active profile is not authorized for current-use execution under an active policy state.

20. The non-transitory computer-readable medium of claim 19, wherein the instructions further cause the one or more processors to log, together with the machine-actionable representation of the renormalised output, at least one of a target-profile identifier, a loop-order value, an arithmetic-mode value, a verification state, provenance metadata, a profile version identifier, a checksum value associated with a profile or executable artifact, a release-eligibility state for control use, a fallback-mode indication, or a blocked, degraded, historical-only, comparison-only, replay-only, or non-control-use state indication.
